(19) United States
(12) Patent Application Publication
(10) Pub. No.: US 2025/0392135 A1
(43) Pub. Date: Dec. 25, 2025

(54) DISTRIBUTED POWER SOURCE INTEGRATED MANAGEMENT APPARATUS, DISTRIBUTED POWER SOURCE MANAGEMENT METHOD, AND STRAGE MEDIUM

(71) Applicant: MITSUBISHI ELECTRIC CORPORATION, Chiyoda-ku, Tokyo (JP)

(72) Inventors: Keishi MATSUDA, Tokyo (JP); Koki MATSUMOTO, Tokyo (JP); Sadayuki INOUE, Tokyo (JP); Rutvikanandan MANOHAR, Tokyo (JP)

(73) Assignee: MITSUBISHI ELECTRIC CORPORATION, Chiyoda-ku, Tokyo (JP)

(21) Appl. No.: 18/880,677

(22) PCT Filed: Jul. 20, 2022
(86) PCT No.: PCT/JP2022/028183

§ 371 Date: Jan. 2, 2025

(51) Int. Cl. H02J 3/38; H02J 3/00; H02J 3/46; H02J 13/00

(52) U.S. Cl. CPC H02J 3/381; H02J 3/003; H02J 3/46; H02J 13/00032; H02J 2300/40

(57) ABSTRACT

A distributed power source integrated management apparatus according to the present disclosure is a distributed power source integrated management apparatus that manages a plurality of distributed power sources that are connected to an independent power system, and operate as voltage sources and operate such that the voltage frequencies vary according to the output power and the voltage frequencies become the same, and includes a drooping characteristic determination unit that determines a relationship between the output power and the output voltage frequency as a drooping characteristic for a controlled distributed power source that is at least some of the plurality of distributed power sources, using output power command values that are command values for the output power of the plurality of distributed power sources, and a communication unit that notifies the controlled distributed power source of characteristic specification information that is information indicating the drooping characteristic.

### FIELD

The present disclosure relates to a distributed power source integrated management apparatus for managing distributed power sources, a power conversion apparatus, a power system management system, a distributed power source management method, and a program.

### BACKGROUND

There is known a technique called virtual synchronous generator (VSG) control to simulatively implement the operating characteristics of a synchronous generator that is a rotating machine in an inverter power source. Using a virtual synchronous generator that is an inverter power source in which virtual synchronous generator control is implemented can impart the abilities of a synchronous generator such as inertial force and synchronizing power to the inverter power source, providing the effect of contributing to the stable operation of a power system with a large capacity proportion of inverter power sources. For example, an independent power system such as a microgrid has a large capacity proportion of inverter power sources. Therefore, the use of virtual synchronous generators as the inverter power sources can be expected to contribute to the stabilization of the independent power system. A virtual synchronous generator has the drooping characteristic that the voltage frequency increases as the output power decreases.

Patent Literature 1 discloses a technique in a system in which a main control power generator that is a voltage-source-type and a subordinate control power generator that is a current-source-type coexist, to make the subordinate control power generator have a drooping characteristic so that when a disturbance of a certain magnitude or more occurs, the main control power generator is prevented from bearing all the disturbance component.

### CITATION LIST

### Patent Literature

Patent Literature 1: Japanese Patent Application Laid-open No. 2011-67078

### SUMMARY OF INVENTION

### Problem to be Solved by the Invention

On the other hand, as distributed power sources, two or more virtual synchronous generators or synchronous generators that are voltage-source-types may be operated in parallel. In Patent Literature 1, the subordinate control power generator is a current-source-type, and the parallel operation of voltage-source-types is not considered. When voltage-source-types are operated in parallel, an imbalance may occur in the output power sharing ratio between the distributed power sources, resulting in the failure of stable operation.

The present disclosure has been made in view of the above. It is an object of the present disclosure to provide a distributed power source integrated management apparatus that can prevent the failure of stable operation of distributed power sources.

### Means to Solve the Problem

To solve the above problems and achieve an object, a distributed power source integrated management apparatus according to the present disclosure is configured to manage a plurality of distributed power sources connected to an independent power system to operate as voltage sources and to operate such that voltage frequencies vary according to output power and the voltage frequencies become the same, the apparatus including: a drooping characteristic determination unit to determine a relationship between the output power and an output voltage frequency as a drooping characteristic for a controlled distributed power source that is at least some of the plurality of distributed power sources, using output power command values that are command values for the output power of the plurality of distributed power sources; and a communication unit to notify the controlled distributed power source of characteristic specification information that is information indicating the drooping characteristic.

### Effects of the Invention

The distributed power source integrated management apparatus according to the present disclosure has the advantage of being able to prevent the failure of stable operation of the distributed power sources.

### BRIEF DESCRIPTION OF DRAWINGS

FIG. 1 is a diagram illustrating an exemplary configuration of a power system management system according to a first embodiment.

FIG. 2 is a diagram illustrating exemplary configurations of an energy management apparatus, a distributed power source integrated management apparatus, and a distributed power source of the first embodiment.

FIG. 3 is a diagram illustrating an exemplary configuration of a virtual synchronous generator control unit of the first embodiment that performs virtual synchronous generator control.

FIG. 4 is a diagram illustrating an example of drooping characteristics in typical virtual synchronous generator control.

FIG. 5 is a diagram illustrating an example of drooping characteristics in the first embodiment.

FIG. 6 is a diagram illustrating an example of drooping characteristics in the first embodiment in a case where charge is allowed.

FIG. 7 is a flowchart illustrating an example of a processing procedure in the distributed power source integrated management apparatus of the first embodiment.

FIG. 8 is a diagram illustrating an exemplary configuration of a computer system that implements the distributed power source integrated management apparatus of the first embodiment.

FIG. 9 is a diagram illustrating an example of drooping characteristics determined by a distributed power source integrated management apparatus of a second embodiment.

FIG. 10 is a diagram illustrating another example of drooping characteristics determined by the distributed power source integrated management apparatus of the second embodiment.

FIG. 11 is a diagram illustrating an exemplary configuration of a power system management system according to a third embodiment.

FIG. 12 is a diagram illustrating an exemplary configuration of a distributed power source integrated management apparatus of the third embodiment.

FIG. 13 is a diagram illustrating an example of drooping characteristics in the third embodiment.

FIG. 14 is a diagram illustrating an exemplary configuration of a power system management system according to a fourth embodiment.

FIG. 15 is a diagram illustrating a detailed exemplary configuration of the distributed power source (power conversion apparatus) illustrated in FIG. 2 according to a fifth embodiment.

FIG. 16 is a diagram illustrating a detailed exemplary configuration of an inverter control circuit illustrated in FIG. 15.

FIG. 17 is a diagram illustrating a detailed exemplary configuration of a frequency generation circuit illustrated in FIG. 16.

### DESCRIPTION OF EMBODIMENTS

Hereinafter, a distributed power source integrated management apparatus, a power conversion apparatus, a power system management system, a distributed power source management method, and a program according to embodiments will be described in detail with reference to the drawings.

### First Embodiment

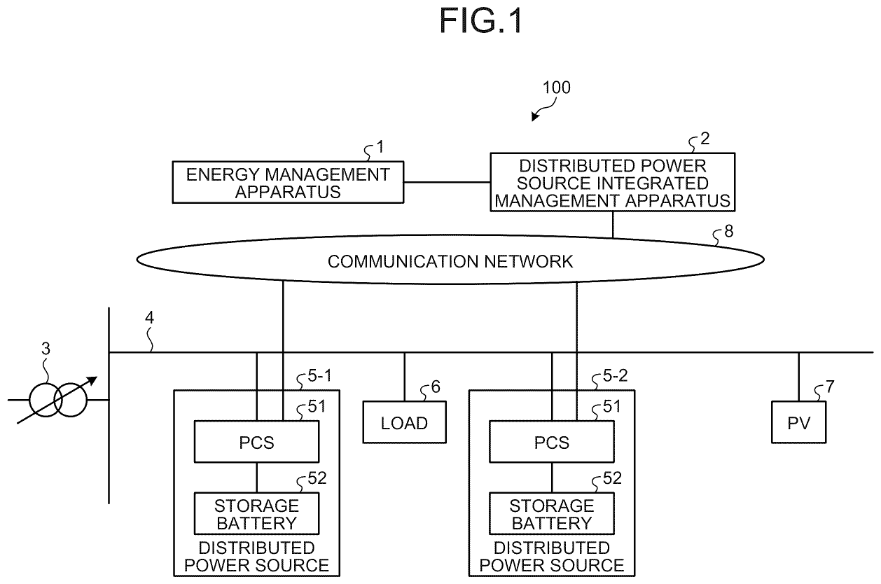

FIG. 1 is a diagram illustrating an exemplary configuration of a power system management system according to a first embodiment. A power system management system 100 of the present embodiment includes an energy management apparatus 1 and a distributed power source integrated management apparatus 2. The power system management system 100 manages, for example, an independent power system in a microgrid. The independent power system is, for example, an independent power system in a smart city, a building, a factory, a remote island, or the like, but the independent power system is not limited thereto.

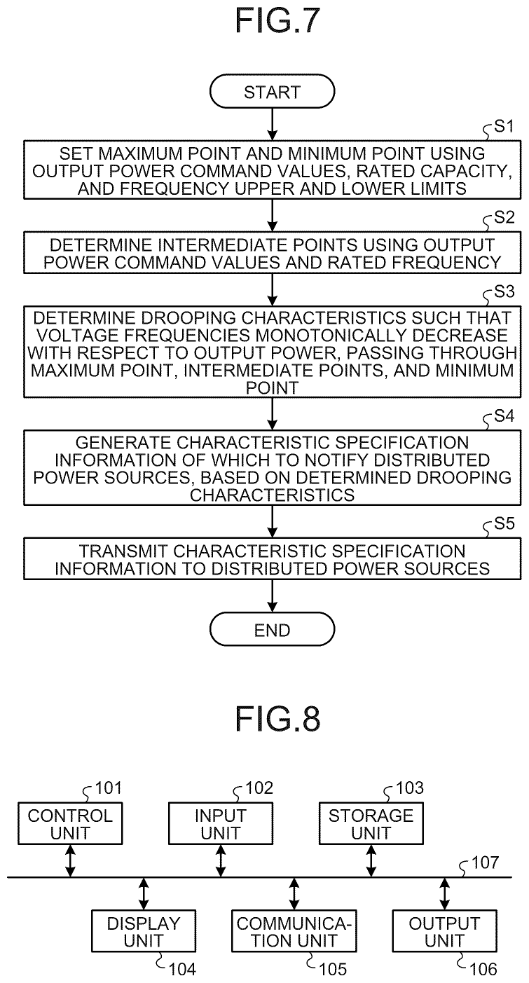

As illustrated in FIG. 1, for example, the independent power system is provided with a distribution line 4 connected to a distribution transformer 3. Distributed power sources 5-1 and 5-2, a load 6, and photovoltaic equipment (abbreviated as PV in the FIG. 7 are connected to the distribution line 4.

The distributed power sources 5-1 and 5-2 operate as voltage sources and have the characteristic that the voltage frequencies vary according to the output power. The distributed power sources 5-1 and 5-2 are, for example, virtual synchronous generators with the operating characteristics of synchronous generators simulatively implemented in inverter power sources, but are not limited thereto, and may be any power sources that operate as voltage sources and determine the voltage frequencies on the basis of the output power, and may be, for example, power sources having the characteristic in which a frequency changing based on the output power has a proportional relationship, or power sources having a first-order lag characteristic.

The distributed power sources 5-1 and 5-2 operate such that the voltage frequencies become the same when control converges. Here, the principle on which the voltage frequencies of the distributed power sources 5-1 and 5-2 converge to be the same will be described. In general, in a case where two power sources operating as voltage sources run in parallel, when the power sources output voltages of different phases, a cross current of active power is generated from the power source (A) whose phase is leading to the power source (B) whose phase is lagging. This cross current is superimposed on the output power originally intended by the power sources, so that the output power of A increases and the output power of B decreases. Consequently, the voltage frequency of A decreases and the voltage frequency of B increases according to the characteristic of each power source that the voltage frequency varies according to the output power, thus acting to eliminate the difference between the voltage phases that has initially existed. The same holds when the phase relationship between A and B is reversed. Thus, the voltage phase difference gradually converges to a constant equilibrium point, and the voltage frequencies match.

The following describes an example in which the distributed power sources 5-1 and 5-2 are virtual synchronous generators, but the distributed power sources 5-1 and 5-2 are not limited thereto as described above, and may be any power sources that operate as voltage sources and determine the voltage frequencies on the basis of the output power. Hereinafter, the distributed power sources 5-1 and 5-2 are referred to as distributed power sources 5 when denoted without individual distinction. Although two distributed power sources 5 are provided in FIG. 1, the number of the distributed power sources 5 only needs to be two or more and is not limited to the example illustrated in FIG. 1. That is, the distributed power sources 5-1 and 5-2 are an example of a plurality of distributed power sources. The distributed power sources 5 are controlled by the distributed power source integrated management apparatus 2. The distributed power sources 5 may be included in the power system management system 100.

The load 6 is equipment that consumes power. FIG. 1 illustrates one load 6, which is not intended to indicate the number of pieces of equipment that consume power, and illustrates a plurality of pieces of equipment collectively as the load 6. Furthermore, FIG. 1 illustrates one load 6 but the connection position is not limited to the example illustrated in FIG. 1. A plurality of loads 6 may be connected in a plurality of places.

The photovoltaic equipment 7 is an example of a current-source-type. The photovoltaic equipment 7 includes photovoltaic panels that perform photovoltaic generation, and a power conditioning subsystem (PCS) that converts DC power generated by the photovoltaic panels into AC power. The photovoltaic equipment 7 is also typically a distributed power source but is a current source distributed power source unlike the distributed power sources 5-1 and 5-2. FIG. 1 illustrates one piece of photovoltaic equipment 7, but the number of pieces of photovoltaic equipment 7 is not limited to the example illustrated in FIG. 1. FIG. 1 illustrates, as a current source source, the photovoltaic equipment 7. However, a current source distributed power source including a storage battery and a PCS, current source wind power equipment that performs wind power generation, or the like may be connected as a current source distributed power source. Some current source distributed power sources are called smart inverters having drooping characteristics. These control the output power using detected frequencies. Therefore, smart inverters are not controlled by the distributed power source integrated management apparatus 2 of the present embodiment, and are distinguished from the distributed power sources 5. A current-source-type can also be regarded as a negative load for the distributed power sources 5 controlled by the distributed power source integrated management apparatus 2.

Although not illustrated in FIG. 1, the distribution line 4 may be provided with equipment such as a pole-mounted transformer, a switch, a circuit breaker, and the like.

The energy management apparatus 1 is an apparatus that manages power supply and demand in the independent power system, such as a community energy management system (CEMS), an aria energy management system (AEMS), or a building and energy management system (BEMS). The energy management apparatus 1 creates a power supply and demand plan, based on the results of prediction of power supply and demand, generates output power command values that are command values for the output power of the distributed power sources 5, based on the supply and demand plan, and transmits the generated output power command values to the distributed power source integrated management apparatus 2.

The distributed power source integrated management apparatus 2 determines the drooping characteristic of each distributed power source 5, using the output power command value received from the energy management apparatus 1, the rated capacity (rated output value) of the distributed power source 5, and frequency constraint information indicating constraints on the voltage frequency (hereinafter, also simply referred to as the frequency), and transmits characteristic specification information indicating the shape of the drooping characteristic to the distributed power source 5. Each distributed power source 5 performs control using the characteristic specification information to perform control based on the specified drooping characteristic.

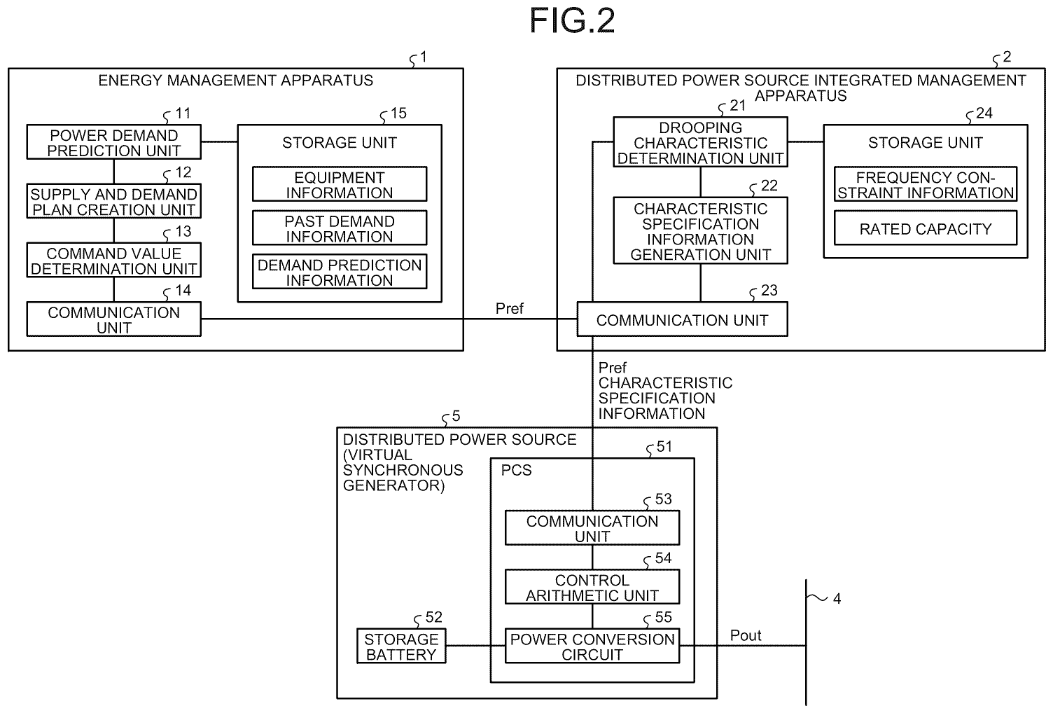

FIG. 2 is a diagram illustrating exemplary configurations of the energy management apparatus 1, the distributed power source integrated management apparatus 2, and the distributed power source 5 in the present embodiment. As illustrated in FIG. 2, the energy management apparatus 1 includes a power demand prediction unit 11, a supply and demand plan creation unit 12, a command value determination unit 13, a communication unit 14, and a storage unit 15.

The storage unit 15 stores equipment information, past demand information, and demand prediction information. The equipment information is information on each piece of equipment in the independent power system, and is, for example, information indicating the rated capacity of each piece of equipment, maximum charge power and maximum discharge power in equipment that performs charge and discharge, and the like. The past demand information is information indicating a record of past demand in the independent power system, that is, a record of past power consumption. The record of past demand includes a record of past generated power generated by power generation equipment using renewable energy, such as the photovoltaic equipment 7 and wind power equipment (not illustrated). This generated power is demand of a negative value (negative power consumption). The past demand information may be the amount of power obtained from automated meter readers called smart meters, or the like, and may include generated power measured by a PCS of the photovoltaic equipment 7, and may include actual values obtained by other means. A record of past demand (actual load) by the load 6 and a record of past generated power may be stored separately in the storage unit 15.

The power demand prediction unit 11 predicts power demand by the use of the past demand information stored in the storage unit 15, and stores the prediction results in the storage unit 15 as demand prediction information (power demand prediction information). The demand prediction information is, for example, predicted values for individual time slots into which a prediction target period is divided by a unit of time predetermined. The prediction may use any method. For example, using the past demand information, mean values for the individual time slots that are classified into weekdays and holidays may be used as the predicted values, and mean values for the individual time slots further classified according to weather may be used as the predicted values. The prediction method is not limited to this example. The demand prediction information includes the predicted values of the generated power (negative demand). The prediction may be performed separately on the record of past demand (actual load) and on the generated power.

The supply and demand plan creation unit 12 creates a power supply and demand plan, using the demand prediction information stored in the storage unit 15. Specifically, using the demand prediction information, the supply and demand plan creation unit 12 determines the output power of the distributed power sources 5 so as to strike a balance of between power supply and demand in each time slot. When there are a generator (not illustrated) that can control the output power among generators other than the distributed power sources 5, the amount of charge and discharge of a device that can control charge and discharge among storage batteries (not illustrated), and the like, the supply and demand plan creation unit 12 also determines the output power, the amount of charge and discharge, and the like of them.

The command value determination unit 13 determines output power command values that are command values for the output power of the distributed power sources 5, based on the supply and demand plan created by the supply and demand plan creation unit 12, and outputs the determined output power command values to the communication unit 14. Note that the supply and demand plan creation unit 12 may not be provided, and the command value determination unit 13 may determine the output power command values for the plurality of distributed power sources 5, using the demand prediction information and the rated output values of the plurality of distributed power sources 5.

The communication unit 14 communicates with other apparatuses. For example, the communication unit 14 transmits the output power command values (the output power command values for the distributed power sources 5) received from the command value determination unit 13 to the distributed power source integrated management apparatus 2. Hereinafter, the output power command value for each distributed power source 5 is also referred to as Pref.

The distributed power source integrated management apparatus 2 includes a drooping characteristic determination unit 21, a characteristic specification information generation unit 22, a communication unit 23, and a storage unit 24.

The communication unit 23 communicates with other apparatuses. For example, the communication unit 23 receives the output power command values for the distributed power sources 5 from the energy management apparatus 1, and outputs the received output power command values to the drooping characteristic determination unit 21. The communication unit 23 transmits the characteristic specification information received from the characteristic specification information generation unit 22 and the output power command values to the corresponding distributed power sources 5 via a communication network 8. That is, the communication unit 23 notifies the distributed power sources 5 of the characteristic specification information that is information indicating the drooping characteristics. The communication network 8 may be a wired network, a wireless network, or a combination thereof, and may be any network.

The storage unit 24 stores the frequency constraint information, which is constraint information on the voltage frequencies in the independent power system, and the rated capacity of each distributed power source 5. The frequency constraint information includes, for example, a rated frequency (reference frequency), a frequency upper limit, and a frequency lower limit. The frequency upper limit and lower limit are indicated as differences from the rated frequency. The frequency upper limit and lower limit are also collectively referred to as frequency upper and lower limits.

The drooping characteristic determination unit 21 uses the output power command values, which are the command values for the output power of the distributed power sources 5-1 and 5-2, to determine the relationship between the output power and the output voltage frequency as a drooping characteristic for a controlled distributed power source that is at least one of the distributed power sources 5-1 and 5-2. Controlled distributed power sources are power sources whose drooping characteristics are specified by the distributed power source integrated management apparatus 2. In the present embodiment, the controlled distributed power sources are the distributed power sources 5-1 and 5-2. The drooping characteristic determination unit 21 determines the drooping characteristic of each distributed power source 5, using the output power command value received from the communication unit 23, the rated capacity stored in the storage unit 24, and the frequency constraint information stored in the storage unit 24, and outputs information indicating the drooping characteristic to the characteristic specification information generation unit 22 together with the output power command value. For example, when the drooping characteristic is a straight line, the information indicating the drooping characteristic may be indicated by coordinate values through which the drooping characteristic passes in an output power-voltage frequency plane, or may be indicated with the voltage frequency as a function with respect to the output voltage. The information indicating the drooping characteristic is not limited thereto. A method of determining a two-dimensional drooping characteristic will be described later.

The characteristic specification information generation unit 22 generates the characteristic specification information to be transmitted to each distributed power source 5, using the information indicating the drooping characteristic, and outputs the generated characteristic specification information to the communication unit 23 together with the output power command value. The characteristic specification information may be the same as or different from the information indicating the drooping characteristic received from the drooping characteristic determination unit 21. Details of the characteristic specification information will be described later.

Each distributed power source 5 includes a PCS 51 and a storage battery 52. The PCS 51 is a power conversion apparatus including an inverter. The PCS 51 includes a communication unit 53, a control arithmetic unit 54, and a power conversion circuit 55. The distributed power source 5 may further include photovoltaic panels (not illustrated), and the photovoltaic panels may be connected to the PCS 51.

The communication unit 53 communicates with other apparatuses. For example, the communication unit 53 receives the characteristic specification information and the output power command value from the distributed power source integrated management apparatus 2 via the communication network 8, and outputs the received characteristic specification information and output power command value to the control arithmetic unit 54. Here, description is given of an example in which the distributed power source 5 receives the output power command value from the distributed power source integrated management apparatus 2, but the distributed power source 5 may receive the output power command value from the energy management apparatus 1.

The control arithmetic unit 54 determines control constants for controlling the power conversion circuit 55, using the characteristic specification information and the output power command value, and controls the power conversion circuit 55 using the determined control constants. The power conversion circuit 55 is a circuit including the inverter, and converts DC power output from the storage battery 52 into AC power when the storage battery 52 is discharged, and converts AC power supplied from the distribution line 4 into DC power and outputs the DC power to the storage battery 52 when the storage battery 52 is charged.

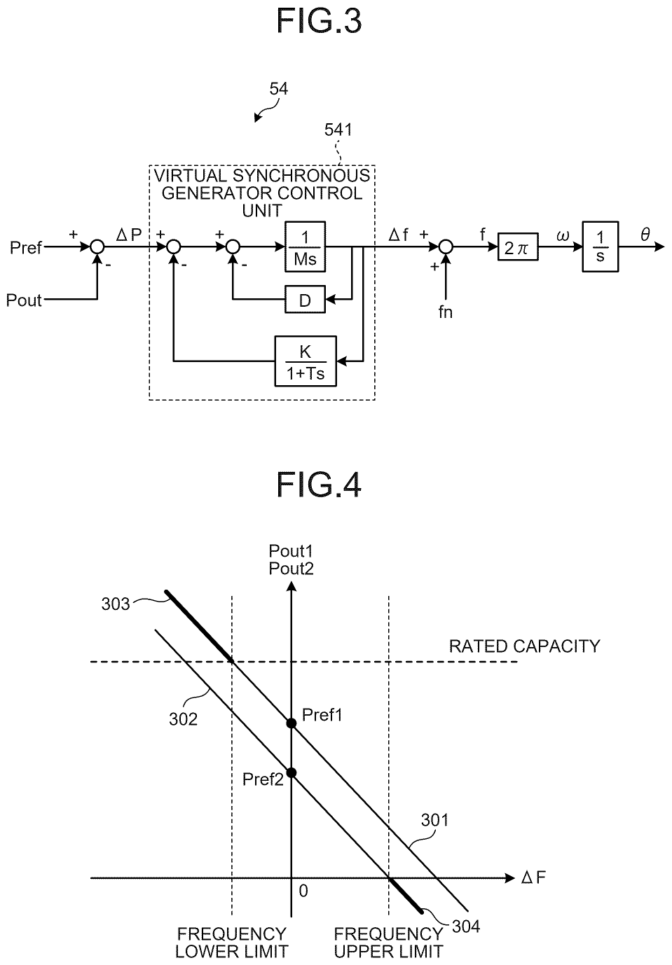

The control arithmetic unit 54 has a function to perform virtual synchronous generator control. FIG. 3 is a diagram illustrating an exemplary configuration of a virtual synchronous generator control unit of the present embodiment that performs virtual synchronous generator control. The control arithmetic unit 54 includes, for example, a virtual synchronous generator control unit 541 illustrated in FIG. 3. A drooping characteristic in typical virtual synchronous generator control will be described with reference to FIG. 3.

The transfer function of the virtual synchronous generator control unit 541 illustrated in FIG. 3 can be expressed by formula (1) below. ΔP is a value obtained by subtracting Pout that is the output power of the distributed power source 5 from Pref, which is the output power command value. ΔF is a value obtained by subtracting the rated frequency from the voltage frequency. M, s, D, K, and T are control constants illustrated in FIG. 3. D is a damping coefficient, K is a governor gain, M is an inertia constant, and T is a governor time constant.

$$\begin{matrix}Formula 1 & \\ {G}_{VSG} ( s ) = \frac{Δ F}{Δ P} = \frac{Ts + 1}{{MTs}^{2} + ( M + DT ) s + ( D + K )} & ( 1 )\end{matrix}$$

A steady gain can be expressed by formula (2) below when s in formula (1) above is set as s→0.

$$\begin{matrix}Formula 2 & \\ {G}_{VSG} ( 0 ) = \frac{Δ F}{Δ P} = \frac{1}{D + K} & ( 2 )\end{matrix}$$

That is, when only steady operation is considered (transient response is ignored), formula (3) below is established.

$$\begin{matrix}Formula 3 & \\ Δ F = \frac{1}{D + K} Δ P = \frac{1}{D + K} ( Pref - Pout ) & ( 3 )\end{matrix}$$

Solving formula (3) above for Pout gives formula (4) below.

$$\begin{matrix}Formula 4 & \\ Pout = Pref - ( D + K ) Δ F & ( 4 )\end{matrix}$$

Formula (4) above is a formula representing the drooping characteristic. That is, the drooping characteristic in the typical virtual synchronous generator control is a straight line with Pref as an intercept and −(D+K) as a slope. FIG. 4 is a diagram illustrating an example of drooping characteristics in the typical virtual synchronous generator control. In a case where the characteristic specification information of the present embodiment is not transmitted to the distributed power sources 5, control constants such as D and K use predetermined values (default values or initial values) for each distributed power source 5. In FIG. 4, the horizontal axis represents ΔF, and the vertical axis represents the output power Pout1 and Pout2 of the distributed power sources 5-1 and 5-2 illustrated in FIG. 1. The vertical axis represents the ratio with respect to the rated capacity. A drooping characteristic 301 is the drooping characteristic of the distributed power source 5-1, and a drooping characteristic 302 is the drooping characteristic of the distributed power source 5-2. For the drooping characteristics 301 and 302 illustrated in FIG. 4, the drooping characteristics are determined using the control constants D and K preset for each of the distributed power sources 5-1 and 5-2. That is, in the example illustrated in FIG. 4, the drooping characteristics 301 and 302 correspond to the drooping characteristics in a state where the distributed power sources 5-1 and 5-2 have not received the characteristic specification information from the distributed power source integrated management apparatus 2, that is, the drooping characteristics in a state where the shapes of the drooping characteristics are not specified from the distributed power source integrated management apparatus 2. In FIG. 4, Pref1 is the output power command value for the distributed power source 5-1 illustrated in FIG. 1, and Pref2 is the output power command value for the distributed power source 5-2 illustrated in FIG. 1. In the example illustrated in FIG. 4, an example is illustrated in which the output power command values Pref1 and Pref2 are discharge command values, and charge is not allowed when the output power command values are discharge command values.

As illustrated in FIG. 4, in a case where the shapes of the drooping characteristics are not specified from the distributed power source integrated management apparatus 2, the drooping characteristics 301 and 302 are determined by formula (4) above based on the control constants determined by the distributed power sources 5. That is, the drooping characteristic 301 is a straight line having the intercept Pref1 and the slope −(D+K), and the drooping characteristic 302 is a straight line having the intercept Pref2 and the slope −(D+K). In this case, as illustrated in FIG. 4, for the distributed power source 5-1, the output power Pout1 exceeds the rated capacity in an area 303 indicated by a thick line at the upper left in the drooping characteristic 301. Since the distributed power sources 5-1 and 5-2 operate such that the voltage frequencies match, points representing ΔF and the output power of the distributed power sources 5-1 and 5-2 are aligned vertically. When ΔF varies, the points move on the drooping characteristics 301 and 302 in a state where the points are vertically aligned. In the example illustrated in FIG. 4, even at ΔF at which the output power Pout1 exceeds the rated capacity, the output power Pout2 of the distributed power source 5-2 is within the rated capacity. However, when the output power Pout1 exceeds the rated capacity, the control fails. Consequently, the supply capacity of the distributed power sources 5-1 and 5-2 that is the total value of the rated capacity of the distributed power source 5-1 and the rated capacity of the distributed power source 5-2 cannot be sufficiently utilized. For the distributed power source 5-2, the output power Pout2 has negative values in an area 304 indicated by a thick line at the lower right in the drooping characteristic 302. Consequently, although the distributed power source 5-2 does not allow charge, charge is performed, and unintended charge is performed.

As described above, in a case where the shapes of the drooping characteristics are not specified, there are imbalances in the output power sharing ratio between the distributed power sources 5-1 and 5-2 near the rated capacity and near zero output power, causing problems that stable operation fails and unintended charge is performed. In the present embodiment, the shapes of the drooping characteristics are determined such that both of the drooping characteristics of the distributed power sources 5-1 and 5-2 pass through the intersection of the frequency lower limit and the rated capacity in the output power-voltage frequency plane. Further, the shapes of the drooping characteristics are determined such that both of the drooping characteristics of the distributed power sources 5-1 and 5-2 pass through the intersection of the frequency upper limit and a straight line representing zero output power in the output power-voltage frequency plane. Consequently, the present embodiment can prevent imbalances in the output power sharing ratio between the distributed power sources 5-1 and 5-2, preventing the failure of stable operation. In addition, the present embodiment can prevent the occurrence of unintended charge.

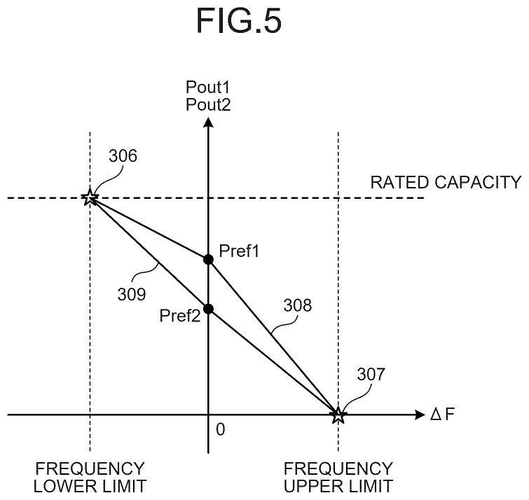

FIG. 5 is a diagram illustrating an example of the drooping characteristics in the present embodiment. In FIG. 5, as in FIG. 4, the horizontal axis represents ΔF, and the vertical axis represents the output power Pout1 and Pout2 of the distributed power sources 5-1 and 5-2 illustrated in FIG. 1. A procedure for determining the drooping characteristics will be described. First, the distributed power source integrated management apparatus 2 determines the frequency upper limit and lower limit to limit the range in which the voltage frequencies of the distributed power sources 5 vary. The frequency upper limit and lower limit may be determined, for example, in accordance with a frequency prescribed range set by a general power transmission and distribution company that manages the independent power system, or may be determined on the basis of frequency ranges required by other power sources connected to the independent power system or consumers. The frequency upper limit and lower limit may be input from the outside. In this case, the distributed power source integrated management apparatus 2 determines the frequency upper limit and lower limit on the basis of the input. In the present embodiment, the drooping characteristics are determined such that when ΔF=0, the output voltages of the distributed power sources 5-1 and 5-2 are Pref1 and Pref2 that are the corresponding output power command values, and when ΔF is the frequency lower limit (frequency lower limit value) that is the voltage frequency lower limit, the output power of each of the distributed power sources 5-1 and 5-2 is the rated capacity. That is, the drooping characteristic of each distributed power source 5 includes a section represented by a straight line passing through an intermediate point that is a point of coordinate values of ΔF=0 and Pout=Pref, and a point 306 at which ΔF is the frequency lower limit and the output power is the rated capacity in the output power-voltage frequency plane. Further, in the present embodiment, the drooping characteristics are determined such that when ΔF is the frequency upper limit (frequency upper limit value) that is the voltage frequency upper limit, the output power of each of the distributed power sources 5-1 and 5-2 is zero. That is, the drooping characteristic of each distributed power source 5 includes a section represented by a straight line passing through the intermediate point, which is the point of coordinate values of ΔF=0 and Pout=Pref, and a point 307 at which ΔF is the frequency upper limit and the output power is zero in the output power-voltage frequency plane.

In the example illustrated in FIG. 5, a drooping characteristic 308 corresponding to the distributed power source 5-1 is represented by a line passing through three points, the point 306, the intermediate point, which is the point of coordinate values of ΔF=0 and Pout1=Pref1, and the point 307, and a drooping characteristic 309 corresponding to the distributed power source 5-2 is represented by a line passing through three points, the point 306, the intermediate point, which is the point of coordinate values of ΔF=0 and Pout2=Pref2, and the point 307. Thus, in the present embodiment, each drooping characteristic is represented by the line passing through the point 306, the intermediate point, which is the point of coordinate values of ΔF=0 and Pout=Pref, and the point 307, and is represented by the line changed in slope at ΔF=0. The point 306 is a point at which ΔF is the frequency lower limit and the output power is the rated capacity, and is a point corresponding to the maximum value of the range of the output power. Thus, hereinafter, the point 306 is also referred to as the maximum point. The point 307 is a point at which ΔF is the frequency upper limit and the output power is zero, and is a point corresponding to the minimum value of the range of the output power. Thus, hereinafter, the point 307 is also referred to as the minimum point.

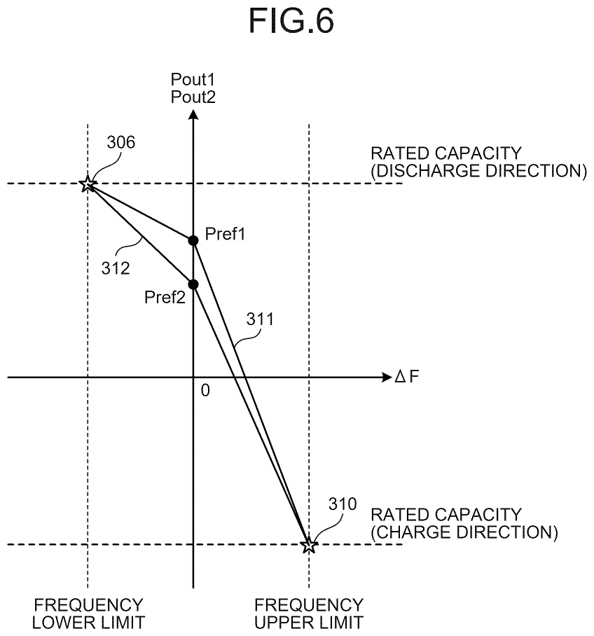

Although FIG. 5 illustrates an example in which charge is not allowed when the output power command values are discharge command values, charge may be allowed in operation when the output power command values are discharge command values. FIG. 6 is a diagram illustrating an example of drooping characteristics of the present embodiment in a case where charge is allowed. In the example illustrated in FIG. 6, the point 306 is the same as that in the example illustrated in FIG. 5, but since charge is allowed, the output power when ΔF is the frequency upper limit is rated capacity (a negative value) in the charge direction. That is, in the example illustrated in FIG. 6, the minimum value of the range of the output power is the rated capacity in the charge direction, and the minimum point is a point 310. In the example illustrated in FIG. 6, a drooping characteristic 311 corresponding to the distributed power source 5-1 is represented by a line passing through three points, the point 306, the intermediate point, which is the point of coordinate values of ΔF=0 and Pout1=Pref1, and the point 310, and a drooping characteristic 312 corresponding to the distributed power source 5-2 is represented by a line passing through three points, the point 306, the intermediate point, which is the point of coordinate values of ΔF=0 and Pout2=Pref2, and the point 310. Thus, the minimum point may be the point at which ΔF is the frequency upper limit and the output power is zero, or may be the point at which ΔF is the frequency upper limit and the output power is the rated capacity in the charge direction. Furthermore, the output power corresponding to the minimum point, that is, the output power when ΔF is the frequency upper limit is not limited to zero and the rated capacity in the charge direction, and may be a value between zero and the rated capacity in the charge direction.

As described above, the drooping characteristic determination unit 21 determines the drooping characteristics such that the output voltages of the plurality of distributed power sources 5 match the rated output values when the voltage frequencies match the frequency lower limit that is the voltage frequency lower limit. That is, the drooping characteristics determined by the drooping characteristic determination unit 21 are, for example, the characteristics that the output voltages of the plurality of distributed power sources 5 match the rated output values when the voltage frequencies are the frequency lower limit, which is the voltage frequency lower limit, in the output power-voltage frequency plane. As illustrated in FIGS. 5 and 6, each drooping characteristic is the characteristic that with the discharge direction as positive output power, the voltage frequency monotonically decreases as the output power increases, the voltage frequency matches the rated frequency when the output power matches the output power command value, which is the command value for the output power, and the output power matches the rated output value for discharge when the voltage frequency matches the frequency lower limit.

Further, each drooping characteristic is the characteristic that the voltage frequency matches the rated frequency when the output power matches the output power command value, which is the command value for the output power, and the ratio of the output power to the rated output value (the absolute value of the rated output value for charge) when the voltage frequency matches the frequency upper limit matches a predetermined value, and the predetermined value is between zero and minus one inclusive. A case where the predetermined value is zero corresponds to the example illustrated in FIG. 5, and a case where the predetermined value is minus one corresponds to the example illustrated in FIG. 6.

In FIGS. 5 and 6, the description has been given of the examples in which the output power command values are discharge command values. However, even when the output power command values are charge command values, that is, when Pref1 and Pref2 are negative values, the drooping characteristics are similarly determined. In this case, as in the example illustrated in FIG. 6, the minimum point is a point at which ΔF is the frequency upper limit and the output power is the rated capacity in the charge direction. When discharge is not allowed, the maximum point is a point at which ΔF is the frequency lower limit and the output power is zero. When discharge is allowed, the maximum point is a point at which ΔF is the frequency lower limit and the output power is the rated capacity (rated output values in the discharge direction). As is the case with the discharge command values, the output power corresponding to the maximum point, that is, the output power when ΔF is the frequency lower limit may be a value between zero and the rated capacity in the discharge direction.

In a case where the distributed power sources 5 are voltage-source-types having drooping characteristics other than virtual synchronous generators, imbalances in the output power sharing ratio can also be prevented by similarly determining the drooping characteristics. In the examples described above, the description has been given of an example in which the frequency upper limit and the frequency lower limit are the voltage frequency upper limit and lower limit in the independent power system. However, the frequency upper limit may be set to a value lower than the voltage frequency lower limit required in the independent power system, and the frequency lower limit may be set to a value higher than the voltage frequency upper limit required in the independent power system.

Next, the operation of the distributed power source integrated management apparatus 2 of the present embodiment will be described. FIG. 7 is a flowchart illustrating an example of a processing procedure in the distributed power source integrated management apparatus 2 of the present embodiment. As illustrated in FIG. 7, the maximum point and the minimum point are set using the output power command values, the rated capacity, and the frequency upper and lower limits (step S1). Specifically, the drooping characteristic determination unit 21 determines whether the output power command values corresponding to the distributed power sources 5 received from the energy management apparatus 1 via the communication unit 23 are discharge command values or charge command values. Then, the drooping characteristic determination unit 21 sets the maximum point and the minimum point using the determination result, the rated capacity of each distributed power source 5 stored in the storage unit 24, and the frequency upper and lower limits in the frequency constraint information stored in the storage unit 24. When the output power command values are discharge command values, as described above, the maximum point is a point at which ΔF is the frequency lower limit and the output power is the rated capacity for discharge. The minimum point when charge is not allowed is a point at which ΔF is the frequency upper limit and the output power is zero. When charge is allowed, the minimum point is, for example, a point at which ΔF is the frequency upper limit and the output power is the rated capacity for charge. Whether or not to allow charge may be specified from the energy management apparatus 1 together with the output power command values, or may be determined in advance, for example. When the output power command values are charge command values, the maximum point and the minimum point are also determined as described above.

Next, the distributed power source integrated management apparatus 2 determines intermediate points using the output power command values and the rated frequency (step S2). Specifically, the drooping characteristic determination unit 21 sets, for each distributed power source 5, a point at which the voltage frequency is the rated frequency and the output power is the output power command value, as the intermediate point. In FIGS. 4 to 6, the horizontal axis represents ΔF, and ΔF=0 corresponds to the rated frequency. Thus, when the horizontal axis represents the voltage frequency f, ΔF=0 corresponds to f being the rated frequency.

Next, the distributed power source integrated management apparatus 2 determines the drooping characteristics such that the voltage frequencies monotonically decrease with respect to the output power, passing through the maximum point, the intermediate points, and the minimum point (step S3). Specifically, as illustrated in FIGS. 5 and 6, for example, the drooping characteristic determination unit 21 determines the drooping characteristic of each distributed power source 5 to form a broken line changed in slope at the intermediate point, and outputs information indicating the determined drooping characteristic to the characteristic specification information generation unit 22. The information indicating the drooping characteristic may indicate the drooping characteristic by the passing points, or may indicate two types of coefficients when two straight lines are represented by linear functions with ΔF=0 as the boundary, or may be other than these. In the examples illustrated in FIGS. 5 and 6, each drooping characteristic is represented by two types of straight lines with different slopes with ΔF=0 as the boundary. For example, it may be determined in advance that the slope changes at ΔF=0 (the value at which f matches the rated frequency), and two slopes on both sides of ΔF=0 may be used as information indicating the drooping characteristic.

Next, the distributed power source integrated management apparatus 2 generates the characteristic specification information of which to notify the distributed power sources 5 on the basis of the determined drooping characteristics (step S4). Specifically, the characteristic specification information generation unit 22 generates the characteristic specification information for each distributed power source 5 on the basis of the information indicating the drooping characteristic that the characteristic specification information generation unit 22 is notified of by the drooping characteristic determination unit 21. The characteristic specification information may be the information indicating the drooping characteristic itself that the characteristic specification information generation unit 22 is notified of by the drooping characteristic determination unit 21. In this case, the characteristic specification information generation unit 22 may not be provided, and the drooping characteristic determination unit 21 may notify the communication unit 23 of the information indicating the drooping characteristic as the characteristic specification information. The characteristic specification information may include the control constants for control in the distributed power sources 5. As described above, since each drooping characteristic can be expressed by formula (4), for example, the characteristic specification information generation unit 22 may include, in the characteristic specification information, information specifying, for D and K, that −(D+K) be the slope of the determined drooping characteristic, or may determine D and K individually so that −(D+K) becomes the slope of the determined drooping characteristic and include the determined D and K values in the characteristic specification information. Since the control constants D and K change with change in slope, the characteristic specification information includes values of D and K and the condition under which the values change. The change condition may be specified by the values of D and K, or may be specified by the voltage frequency or the output power. As described above, since the slope changes at ΔF=0, the characteristic specification information generation unit 22 determines the control constants for each of the two straight lines on both sides of ΔF=0 and includes the determined control constants in the characteristic specification information. The condition related to the point that the slope changes, that is, the change in slope at ΔF=0 may be determined in advance, or may be provided by the notification of the characteristic specification information. The condition under which the values of the control constants change may be specified by the rated frequency and ΔF, or may be specified by the frequency F. Alternatively, the condition under which the values of the control constants change may be specified by the value of the output power Pout.

As described above, each piece of characteristic specification information may include coordinate values through which the line representing the drooping characteristic passes in the output power-voltage frequency plane, or may include the slope of the line representing the drooping characteristic in the output power-voltage frequency plane and the condition under which the slope changes. Alternatively, each piece of characteristic specification information may include information indicating the values of control constants corresponding to the drooping characteristic and the condition under which the values of the control constants change. The control constants are, for example, control constants used for virtual synchronous generator control.

Next, the distributed power source integrated management apparatus 2 transmits the characteristic specification information to the distributed power sources 5 (step S5), and ends the processing. Specifically, in step S5, the characteristic specification information generated by the characteristic specification information generation unit 22 is output to the communication unit 23, and the communication unit 23 transmits the characteristic specification information to the corresponding distributed power sources 5.

By the above processing, the distributed power sources 5 receive the characteristic specification information. The distributed power sources 5 perform control using the drooping characteristics based on the characteristic specification information. Consequently, when the frequency decreases, the distributed power sources 5 can perform control such that the output power of the distributed power sources 5 becomes the rated capacity at the same time as the frequency decreases, preventing an imbalance in the output power sharing ratio. This allows effective utilization of the supply capacity of the distributed power sources 5. In the examples described above, the drooping characteristics on both sides of ΔF=0 are adjusted, but the drooping characteristic determination method of the present embodiment may be applied to one side. For example, the method may be applied to the case where ΔF is negative, that is, to the side on which the frequency decreases, to achieve the effect of enabling the effective utilization of the supply capacity of the distributed power sources 5 at the time of discharge. Further, for example, the method may be applied to the case where ΔF is positive, that is, to the side on which the frequency increases, to achieve the effect of preventing unintended charge operation at the time of discharge.

When three or more distributed power sources 5 are provided, the distributed power source integrated management apparatus 2 can likewise determine the drooping characteristics of the three or more distributed power sources 5 such that each of the drooping characteristics of the distributed power sources 5 is represented by a straight line passing through the maximum point and the intermediate point and a straight line passing through the intermediate point and the minimum point.

Next, a hardware configuration of the distributed power source integrated management apparatus 2 of the present embodiment will be described. For the distributed power source integrated management apparatus 2 of the present embodiment, when a program that is a computer program describing the processing in the distributed power source integrated management apparatus 2 is executed on a computer system, the computer system functions as the distributed power source integrated management apparatus 2. FIG. 8 is a diagram illustrating an exemplary configuration of a computer system that implements the distributed power source integrated management apparatus 2 of the present embodiment. As illustrated in FIG. 8, the computer system includes a control unit 101, an input unit 102, a storage unit 103, a display unit 104, a communication unit 105, and an output unit 106, which are connected via a system bus 107. The control unit 101 and the storage unit 103 constitute processing circuitry.

In FIG. 8, the control unit 101 is, for example, a processor such as a central processing unit (CPU), and executes a program describing the processing in the distributed power source integrated management apparatus 2 of the present embodiment. Note that part of the control unit 101 may be implemented by dedicated hardware such as a graphics processing unit (GPU) or a field-programmable gate array (FPGA). The input unit 102 includes, for example, a keyboard and a mouse, and is used by a user of the computer system to input various types of information. The storage unit 103 includes various types of memory such as random-access memory (RAM) and read-only memory (ROM) and a storage device such as a hard disk, and stores the program to be executed by the above control unit 101, necessary data obtained during the processing, and the like. The storage unit 103 is also used as a temporary storage area for the program. The display unit 104 includes a display, a liquid crystal display (LCD) panel, or the like, and displays various screens for the user of the computer system. The communication unit 105 is a receiver and a transmitter that perform communication processing. The output unit 106 is a printer, a speaker, or the like. Note that FIG. 8 is an example, and the configuration of the computer system is not limited to the example of FIG. 8.

Here, an example of operation of the computer system before the program of the present embodiment becomes executable will be described. In the computer system having the above-described configuration, the computer program is installed in the storage unit 103, for example, from a compact disc (CD)-ROM or a digital versatile disc (DVD)-ROM set in a CD-ROM drive or a DVD-ROM drive (not illustrated). At the time of execution of the program, the program read from the storage unit 103 is stored in the main storage area of the storage unit 103. In this state, the control unit 101 performs the processing as the distributed power source integrated management apparatus 2 of the present embodiment, according to the program stored in the storage unit 103.

In the above description, the program describing the processing in the distributed power source integrated management apparatus 2 is provided with the CD-ROM or DVD-ROM as a recording medium, which is not limiting. For example, the program provided through a transmission medium such as the Internet via the communication unit 105 may be used, depending on the configuration of the computer system, the capacity of the provided program, and the like.

The program of the present embodiment causes the distributed power source integrated management apparatus 2 to perform, for example, a step of determining the relationships between output power and output voltage frequencies as drooping characteristics for a controlled distributed power source that is at least some of a plurality of distributed power sources, using output power command values, and a step of notifying the controlled distributed power source of characteristic specification information that is information indicating the drooping characteristics.

The drooping characteristic determination unit 21 and the characteristic specification information generation unit 22 illustrated in FIG. 2 are implemented by the control unit 101 illustrated in FIG. 8 executing the computer program stored in the storage unit 103 illustrated in FIG. 8. The storage unit 103 illustrated in FIG. 8 is also used to implement the drooping characteristic determination unit 21 and the characteristic specification information generation unit 22 illustrated in FIG. 2. The storage unit 24 illustrated in FIG. 2 is part of the storage unit 103 illustrated in FIG. 8. The communication unit 23 illustrated in FIG. 2 is implemented by the communication unit 105 illustrated in FIG. 8. The distributed power source integrated management apparatus 2 may be implemented by a plurality of computer systems. For example, the distributed power source integrated management apparatus 2 may be implemented by a cloud computer system.

The energy management apparatus 1 illustrated in FIG. 2 is similarly implemented, for example, by the computer system illustrated in FIG. 8. The power demand prediction unit 11, the supply and demand plan creation unit 12, and the command value determination unit 13 illustrated in FIG. 2 are implemented by the control unit 101 illustrated in FIG. 8 executing a computer program stored in the storage unit 103 illustrated in FIG. 8. The storage unit 103 illustrated in FIG. 8 is also used to implement the power demand prediction unit 11, the supply and demand plan creation unit 12, and the command value determination unit 13 illustrated in FIG. 2. The storage unit 15 illustrated in FIG. 2 is part of the storage unit 103 illustrated in FIG. 8. The communication unit 14 illustrated in FIG. 2 is implemented by the communication unit 105 illustrated in FIG. 8. The energy management apparatus 1 may be implemented by a plurality of computer systems. For example, the energy management apparatus 1 may be implemented by a cloud computer system.

The control arithmetic unit 54 in the distributed power source 5 illustrated in FIG. 2 is implemented, for example, by processing circuitry. The processing circuitry may be processing circuitry including the control unit 101 and the storage unit 103, or part or all of the processing circuitry may be a dedicated circuit such as a field-programmable gate array (FPGA) or an application-specific integrated circuit (ASIC).

As described above, in the present embodiment, the distributed power source integrated management apparatus 2 determines the upper limit and the lower limit of the output voltage frequencies of the distributed power sources 5, determines the drooping characteristics of the distributed power sources 5 based on the determined upper limit and lower limit of the output voltage frequencies, the rated capacity of the distributed power sources 5, and the output power command values for the distributed power sources 5, and transmits the characteristic specification information specifying the drooping characteristics to the distributed power sources 5. This allows the stable operation of the distributed power sources 5 to be continued.

### Second Embodiment

Next, drooping characteristics in a second embodiment will be described. The configuration of the power system management system 100 of the present embodiment is the same as that of the first embodiment. The configurations of the energy management apparatus 1 and the distributed power source integrated management apparatus 2 are also the same as those of the first embodiment. Hereinafter, differences from the first embodiment will be mainly described, and redundant description will be omitted.

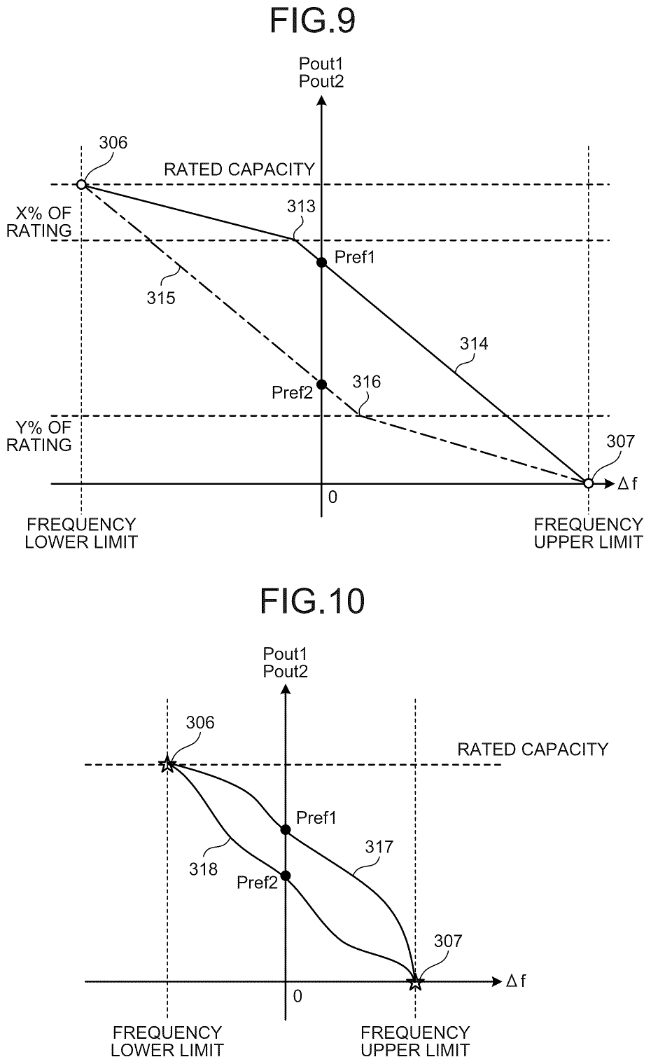

FIG. 9 is a diagram illustrating an example of drooping characteristics determined by the distributed power source integrated management apparatus 2 of the present embodiment. The points 306 and 307 illustrated in FIG. 9 are the same as those in the example illustrated in FIG. 5. In the first embodiment, each drooping characteristic is represented by a combination of two types of straight lines, a straight line passing through the maximum point and the intermediate point and a straight line passing through the intermediate point and the minimum point, and the slope of the line changes at the intermediate point. In the example illustrated in FIG. 9, each drooping characteristic is similarly represented by a combination of two types of straight lines, a straight line passing through the maximum point and the intermediate point and a straight line passing through the intermediate point and the minimum point, but ΔF corresponding to the intermediate point as the boundary is different for each distributed power source 5.

In the example illustrated in FIG. 9, the drooping characteristics are also determined such that when ΔF=0, the output power of the distributed power sources 5-1 and 5-2 is the output power command values Pref1 and Pref2, respectively. With a point 313 corresponding to X % of the rated capacity (X % of the rating) as the intermediate point, a drooping characteristic 314 of the distributed power source 5-1 is represented by a combination of two types of straight lines, a straight line passing through the point 306 and the point 313, which is the intermediate point, and a straight line passing through the point 313 and the point 307. The point 313 is a point at which a straight line passing through the point 307 and a point at which ΔF=0 and the output power is Pref1 intersects a straight line corresponding to X % of the rating. With a point 316 corresponding to Y % of the rated capacity (Y % of the rating) as the intermediate point, a drooping characteristic 315 of the distributed power source 5-2 is represented by a combination of two types of straight lines, a straight line passing through the point 306 and the point 316, which is the intermediate point, and a straight line passing through the point 316 and the point 307. The point 316 is a point at which a straight line passing through the point 306 and a point at which ΔF=0 and the output power is Pref2 intersects a straight line corresponding to Y % of the rating. As illustrated in FIG. 9, the intermediate points at which the slopes of the lines representing the drooping characteristics change are not limited to those in the example of the first embodiment, and may be other than the points corresponding to ΔF=0.

In the example illustrated in FIG. 9, the lines representing the drooping characteristics each change in slope at one point, but may change in slope at a plurality of points. That is, each drooping characteristic may be a line that changes in slope at two or more points as long as the characteristic is that the output power matches the output power command value at ΔF=0, the line passes through the maximum point and the minimum point, and the voltage frequency monotonically decreases as the output power increases. In the example illustrated in FIG. 9, for example, the distributed power source integrated management apparatus 2 can generate the condition under which the slope changes (such as coordinate values at which the slope changes) and the slope in each section as the characteristic specification information.

FIG. 10 is a diagram illustrating another example of drooping characteristics determined by the distributed power source integrated management apparatus 2 of the present embodiment. In the example illustrated in FIG. 10, drooping characteristics 317 and 318 corresponding to the distributed power sources 5-1 and 5-2, respectively, are curves. Thus, each drooping characteristic may be a curve as long as the characteristic is that the output power matches the output power command value at ΔF=0, the curve passes through the maximum point and the minimum point, and the voltage frequency monotonically decreases as the output power increases. When the drooping characteristics are curves, for example, each curve is determined by a formula such as a polynomial, and the distributed power source integrated management apparatus 2 determines the drooping characteristic by determining coefficients in the polynomial or the like such that the output power matches the output power command value at ΔF=0 and the curve passes through the maximum point and the minimum point. FIGS. 9 and 10 illustrate examples in which the output power command values are discharge command values. When the output power command values are charge command values, likewise, a different intermediate point may be set for each distributed power source 5, or the drooping characteristics may be curves.

As described above, the present embodiment has illustrated the drooping characteristics of the shapes different from those of the first embodiment. Thus, the drooping characteristics determined by the distributed power source integrated management apparatus 2 are not limited to those in the example described in the first embodiment. When the drooping characteristics described in the present embodiment are used, the same effects as those of the first embodiment can also be obtained.

### Third Embodiment

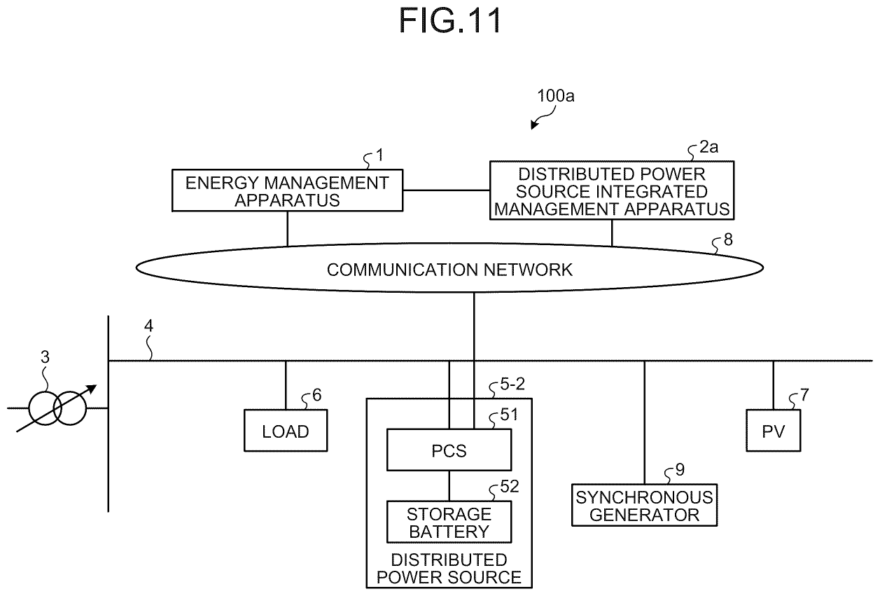

FIG. 11 is a diagram illustrating an exemplary configuration of a power system management system according to a third embodiment. A power system management system 100a of the present embodiment is the same as the power system management system 100 of the first embodiment except that a distributed power source integrated management apparatus 2a is provided instead of the distributed power source integrated management apparatus 2. Components having the same functions as those of the first embodiment are denoted by the same reference numerals as those in the first embodiment to omit redundant description. Hereinafter, differences from the first embodiment will be mainly described.

As in the first embodiment, an independent power system managed by the power system management system 100a is, for example, an independent power system in a smart city, a building, a factory, a remote island, or the like, but the independent power system is not limited thereto. The independent power system managed by the power system management system 100a is the same as the independent power system of the first embodiment except that a synchronous generator 9 is provided instead of the distributed power source 5-1. The distributed power source 5-2 and the synchronous generator 9 may be included in the power system management system 100a. Although one distributed power source 5 is illustrated in FIG. 11, a plurality of the distributed power sources 5 may be provided. In the present embodiment, the distributed power source 5 and the synchronous generator 9 are an example of a plurality of distributed power sources, and a controlled distributed power source is the distributed power source 5.

In the present embodiment, the synchronous generator 9 is provided as a distributed power source, and the synchronous generator 9 and the distributed power source 5-2 operate to match the voltage frequencies. The synchronous generator 9 has a drooping characteristic. However, the drooping characteristic of the synchronous generator 9 is a characteristic determined by the hardware configuration unlike the drooping characteristic of a virtual synchronous generator, and cannot be changed by specification from the distributed power source integrated management apparatus 2a. Therefore, in the present embodiment, frequency upper and lower limits are determined based on the drooping characteristic of the synchronous generator 9, and the drooping characteristic of the distributed power source 5-2 is determined using the determined upper and lower limits as in the embodiment.

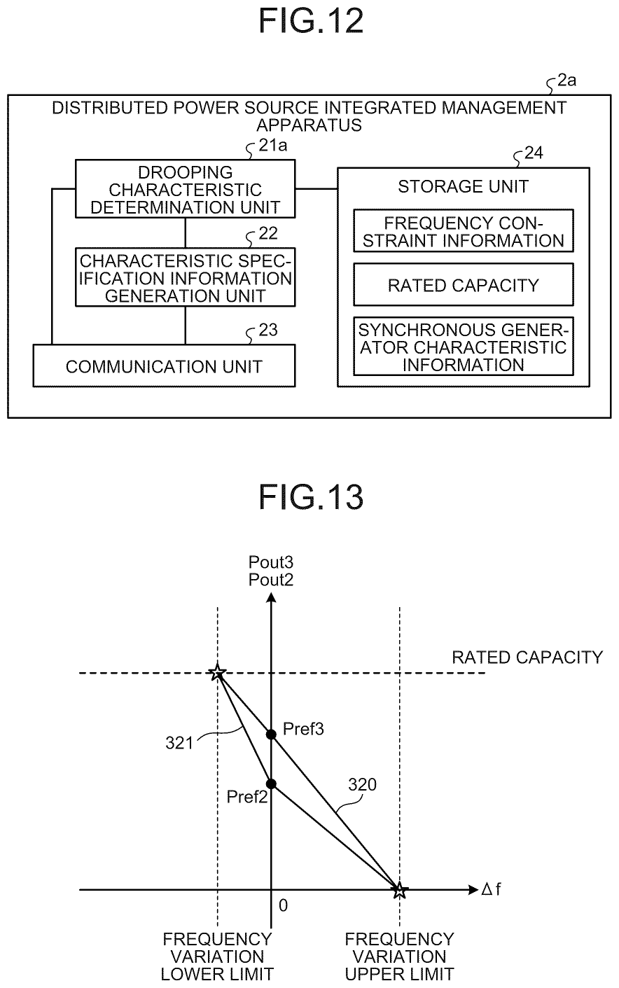

FIG. 12 is a diagram illustrating an exemplary configuration of the distributed power source integrated management apparatus 2a of the present embodiment. As illustrated in FIG. 12, the distributed power source integrated management apparatus 2a of the present embodiment is the same as the distributed power source integrated management apparatus 2 of the first embodiment except that a drooping characteristic determination unit 21a is provided instead of the drooping characteristic determination unit 21, and synchronous generator characteristic information is added to the information stored in the storage unit 24. The synchronous generator characteristic information is information indicating the drooping characteristic of the synchronous generator 9.

FIG. 13 is a diagram illustrating an example of drooping characteristics in the present embodiment. The drooping characteristic determination unit 21a determines a frequency variation lower limit that is a frequency lower limit, using the synchronous generator characteristic information stored in the storage unit 24 and the rated capacity of the distributed power source 5-2 stored in the storage unit 24. As illustrated in FIG. 13, a drooping characteristic 320 of the synchronous generator 9 is a straight line, and the output power matches an output command value Pref3 at the rated frequency. In the present embodiment, a frequency corresponding to the intersection of the straight line representing the drooping characteristic 320 of the synchronous generator 9 and a straight line representing the rated capacity of the distributed power source 5-2 is the frequency variation lower limit. A frequency corresponding to the intersection of the drooping characteristic 320 of the synchronous generator 9 and a straight line representing zero output power is the frequency variation upper limit. The drooping characteristic determination unit 21a determines a drooping characteristic 321 of the distributed power source 5-2, based on the output power command value, the frequency variation upper limit, and the frequency variation lower limit as in the first embodiment. The operation of the present embodiment other than that described above is the same as that of the first embodiment. When a plurality of the distributed power sources 5 are provided, the drooping characteristic of each distributed power source 5 is likewise determined based on the output power command value, the frequency variation upper limit, and the frequency variation lower limit.

As described above, the drooping characteristic determination unit 21a sets the voltage frequency at the point in the straight line representing the drooping characteristic of the synchronous generator 9 at which the output voltage matches the rated output value for discharge of the distributed power source 5, which is the controlled distributed power source, as the frequency lower limit, and sets the voltage frequency at the point in the straight line representing the drooping characteristic of the synchronous generator at which the output voltage is zero as the frequency upper limit, and determines the drooping characteristic of the distributed power source 5.

Like the distributed power source integrated management apparatus 2 of the first embodiment, the distributed power source integrated management apparatus 2a of the present embodiment is implemented, for example, by the computer system illustrated in FIG. 8.

As described above, in the present embodiment where the synchronous generator 9 is included as a distributed power source, the frequency variation upper limit and the frequency variation lower limit are determined based on the drooping characteristic of the synchronous generator 9, and the drooping characteristic of the distributed power source 5 is determined as in the first embodiment. Therefore, when the synchronous generator 9 is included as a distributed power source, the same effects as those of the first embodiment can be obtained. In the example described above, the drooping characteristic is determined as in the first embodiment. However, as described in the second embodiment, the drooping characteristic of the distributed power source 5 may be determined with the intermediate point shifted from the point corresponding to ΔF=0, or the drooping characteristic of the distributed power source 5 may be represented by a curve.

### Fourth Embodiment

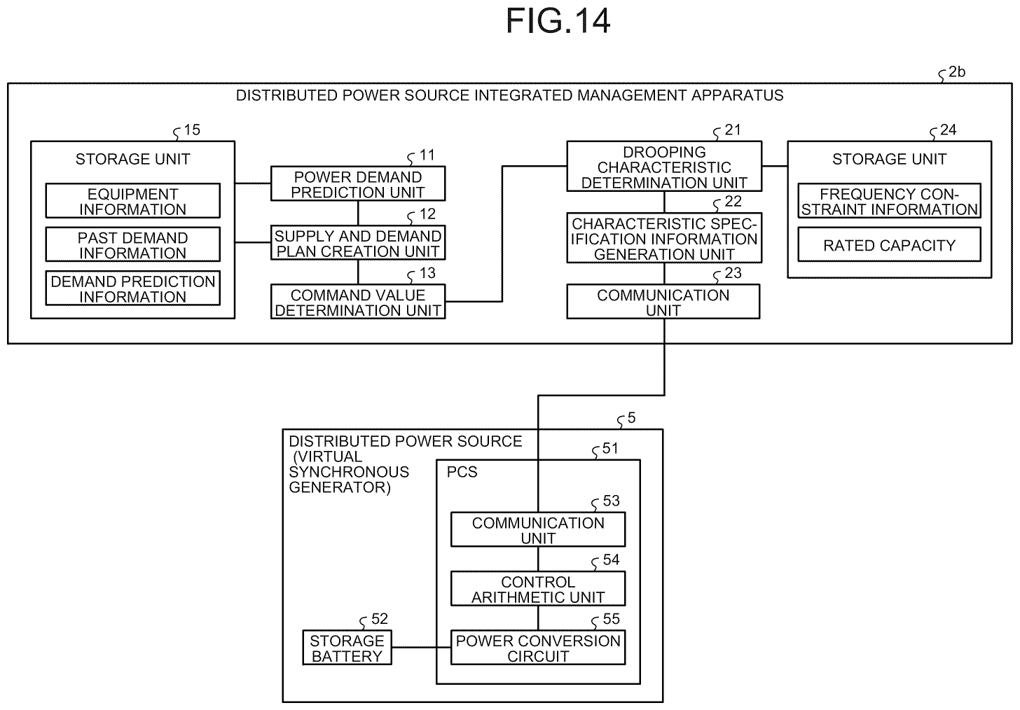

FIG. 14 is a diagram illustrating an exemplary configuration of a power system management system according to a fourth embodiment. The power system management system of the present embodiment includes a distributed power source integrated management apparatus 2b. The distributed power source integrated management apparatus 2b is an apparatus that combines the energy management apparatus 1 and the distributed power source integrated management apparatus 2 of the first embodiment, and is a distributed power source integrated management apparatus and an energy management apparatus. The distributed power source integrated management apparatus 2b may be, for example, an energy management apparatus for managing power supply and demand to which a function to determine drooping characteristics is added. The distributed power sources 5 may be included in the power system management system. Components having the same functions as those of the first embodiment are denoted by the same reference numerals as those in the first embodiment to omit redundant description. Hereinafter, differences from the first embodiment will be mainly described.

The distributed power source integrated management apparatus 2b is obtained by adding the power demand prediction unit 11, the supply and demand plan creation unit 12, the command value determination unit 13, and the storage unit 15 of the energy management apparatus 1 in the first embodiment to the distributed power source integrated management apparatus 2 in the first embodiment. Although the storage unit 15 and the storage unit 24 are separately illustrated in FIG. 14, the storage unit 15 and the storage unit 24 may be integrated into one storage unit.

In the present embodiment, the command value determination unit 13 outputs the determined output power command values for the distributed power sources 5 to the drooping characteristic determination unit 21. The operation of the present embodiment other than that described above is the same as that of the first embodiment.

Like the distributed power source integrated management apparatus 2 of the first embodiment, the distributed power source integrated management apparatus 2b of the present embodiment is implemented, for example, by the computer system illustrated in FIG. 8. The distributed power sources may be included in the power system management system of the present embodiment.

As described above, the distributed power source integrated management apparatus 2b may also have the function to generate the output power command values. FIG. 14 illustrates an example in which the distributed power source integrated management apparatus 2b also predicts demand. However, the prediction of demand may be performed by another apparatus, and the distributed power source integrated management apparatus 2b may acquire demand prediction information from the said apparatus. In this case, the distributed power source integrated management apparatus 2b may not include the power demand prediction unit 11. Further, the prediction of demand and the creation of a supply and demand plan may be performed by another apparatus, and the distributed power source integrated management apparatus 2b may acquire the supply and demand plan from the said apparatus. In this case, the distributed power source integrated management apparatus 2b may not include the power demand prediction unit 11 and the supply and demand plan creation unit 12.

Furthermore, as described in the second embodiment, the distributed power source integrated management apparatus 2b may determine the drooping characteristic of each distributed power source 5 with the intermediate point shifted from the point corresponding to ΔF=0, or may determine the drooping characteristic of each distributed power source 5 represented by a curve. Moreover, the distributed power source integrated management apparatus 2b may include the drooping characteristic determination unit 21a of the third embodiment instead of the drooping characteristic determination unit 21. In the independent power system provided with the synchronous generator 9 and the distributed power source 5, the distributed power source integrated management apparatus 2b may determine the frequency variation upper limit and the frequency variation lower limit, using the drooping characteristic of the synchronous generator 9, and determine the drooping characteristic of the distributed power source 5 as in the third embodiment.

### Fifth Embodiment

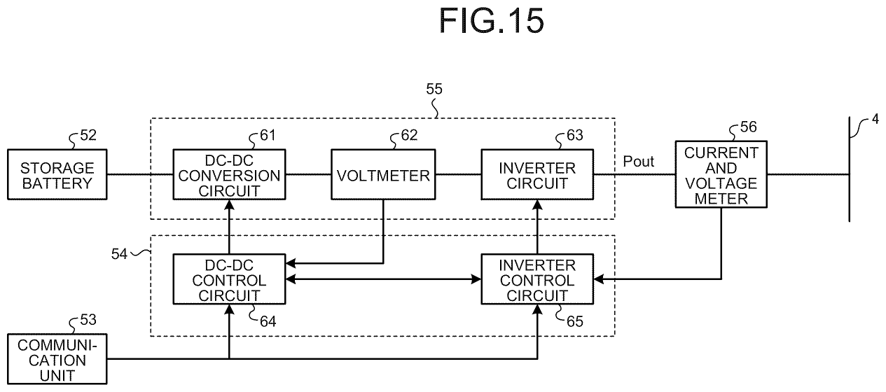

FIG. 15 is a diagram illustrating a detailed exemplary configuration of the distributed power source (power conversion apparatus) 5 illustrated in FIG. 2 according to a fifth embodiment. In the drawings described in the fifth embodiment, components having the same functions as those of the first to fourth embodiments described above are denoted by the same reference numerals as those of the first to fourth embodiments to omit redundant description. Hereinafter, differences from the first to fourth embodiments will be mainly described. In the distributed power source 5 illustrated in FIG. 15, the control arithmetic unit 54 and the power conversion circuit 55 illustrated in FIG. 2 are described in detail, and a current and voltage meter 56 not illustrated in FIG. 2 is added. The current and voltage meter (AC voltage measurement unit) 56 measures an AC current (AC system current) and an AC voltage (AC system voltage), and outputs measurement information indicating the measurement results to the control arithmetic unit 54.

The power conversion circuit 55 includes a direct current (DC)-DC conversion circuit 61, a voltmeter 62, and an inverter circuit 63. The DC-DC conversion circuit 61 converts a first DC voltage output from the storage battery 52 into a second DC voltage. The voltmeter 62 measures the second DC voltage output from the DC-DC conversion circuit 61. The inverter circuit (inverter unit) 63 converts the second DC voltage (power) output from the DC-DC conversion circuit 61 into an AC voltage (power) to be an output from the distributed power source.

The control arithmetic unit 54 includes a DC-DC control circuit 64 and an inverter control circuit 65. The DC-DC control circuit 64 controls the DC-DC conversion circuit 61. The inverter control circuit 65 controls the inverter circuit 63. The control arithmetic unit 54 includes the DC-DC control circuit 64 and the inverter control circuit 65.

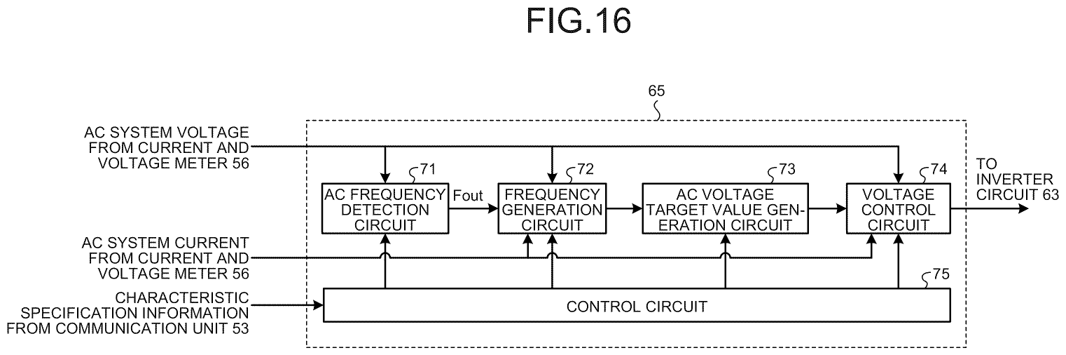

FIG. 16 is a diagram illustrating a detailed exemplary configuration of the inverter control circuit 65 illustrated in FIG. 15. As illustrated in FIG. 16, the inverter control circuit 65 includes an AC frequency detection circuit (frequency acquisition unit) 71, a frequency generation circuit (frequency generation unit) 72, an AC voltage target value generation circuit (AC target voltage generation unit) 73, a voltage control circuit 74, and a control circuit (inverter control unit) 75. The AC frequency detection circuit 71 detects the frequency of the AC system voltage from the measurement information output from the current and voltage meter 56. In the present embodiment, the AC frequency detection circuit 71 also detects the voltage phase of the AC system voltage. The frequency generation circuit 72 calculates the frequency and the phase of the AC system voltage to be output from the inverter circuit 63, based on the frequency of the AC system voltage output from the AC frequency detection circuit 71, the measurement information output from the current and voltage meter 56, and various types of information provided in the notification from the distributed power source integrated management apparatus 2. The AC voltage target value generation circuit 73 calculates a target value of the AC system voltage to be output from the inverter circuit 63, based on the frequency of the AC system voltage calculated by the frequency generation circuit 72 and phase information of the AC system voltage detected by the AC frequency detection circuit 71. When the AC voltage target value generation circuit 73 calculates a target value of the AC system voltage, it goes without saying that for the AC system voltage phase, phase information of the AC system voltage calculated by the frequency generation circuit 72 may be used.

The voltage control circuit 74 generates a command value for the voltage control of the inverter circuit 63, based on the target value of the AC system voltage output from the AC voltage target value generation circuit 73. The control circuit 75 controls the AC frequency detection circuit 71, the frequency generation circuit 72, the AC voltage target value generation circuit 73, and the voltage control circuit 74, based on the characteristic specification information provided in the notification from the distributed power source integrated management apparatus 2 via the communication unit 53. The characteristic specification information is the information indicating the drooping characteristic described in the first to fourth embodiments, and here includes an AC system frequency reference value Fref. The AC system frequency reference value Fref corresponds to the rated frequency (reference frequency) described in the first embodiment and others. The following describes an example in which the characteristic specification information includes information indicating the slope of the drooping characteristic and a point at which the slope changes, and the point at which the slope changes is specified by ΔF. However, as described in the first embodiment, the information for specifying the drooping characteristic in the characteristic specification information is not limited to this example.

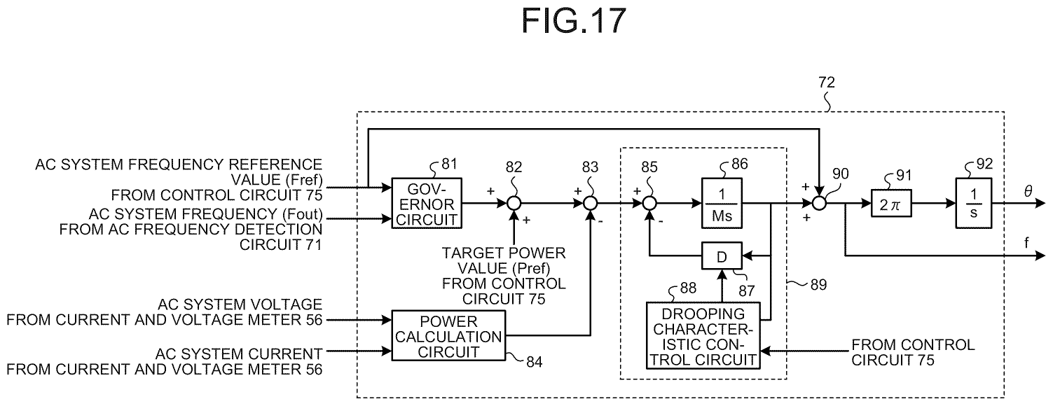

FIG. 17 is a diagram illustrating a detailed exemplary configuration of the frequency generation circuit 72 illustrated in FIG. 16. The fifth embodiment describes a case where the exemplary configuration of the frequency generation circuit 72 uses the virtual synchronous generator control system described in the first embodiment. Note that the configuration of the frequency generation circuit 72 is not limited to the virtual synchronous generator control system illustrated in FIG. 17, and may be a virtual synchronous generator control system of another configuration. If the virtual synchronous generator control system of the other configuration provides drooping characteristics as described in the other embodiments, for example, as illustrated in FIGS. 5, 6, 9, 10, and 13, it is needless to say that the same effects are achieved. Return to the description of FIG. 17. As illustrated in FIG. 17, the frequency generation circuit 72 includes a governor circuit 81, adders 82 and 90, a subtractor 83, a power calculation circuit 84, an arithmetic unit 89, a multiplier 91, and an integrator 92. The arithmetic unit 89 is an arithmetic unit that simulates the swing equation of a synchronous generator in the virtual synchronous generator control unit that simulates the transient characteristics of the synchronous generator, and includes an inertia unit that simulates the inertia of a mechanical rotor and a damping unit that simulates damping force to apply the damping force to the mechanical rotor. Specifically, as illustrated in FIG. 17, for example, the arithmetic unit 89 includes a subtractor 85, an integrator 86, a multiplier 87, and a drooping characteristic control circuit 88. The arithmetic unit 89 can set an inertia constant to simulate the inertia of the mechanical rotor and a damping coefficient to simulate the damping effect of the mechanical rotor each to at least two types of value of different values. These two types of value are set on the basis of the characteristic specification information provided in the notification by the distributed power source integrated management apparatus 2.

The governor circuit 81 calculates an offset value to be added to a target power value (Pref) output from the control circuit 75, based on the AC system frequency reference value (Fref) that the control circuit 75 is notified of via the communication unit 53 and the frequency detection result of the AC system voltage (Fout) output from the AC frequency detection circuit 71. The adder 82 adds the output of the governor circuit 81 and the target power value (Pref). The subtractor 83 subtracts the output of the power calculation circuit 84 from the output of the adder 82. The subtractor 85 subtracts the output of the multiplier 87 from the output of the subtractor 83. The integrator 86 multiplies the output of the subtractor 85 by 1/M (M is the inertia constant) and integrates to generate and output ΔF information indicating ΔF. The multiplier 87 multiplies the output of the integrator 86 by the damping coefficient D to give, for example, the drooping characteristic illustrated in FIG. 5. Specifically, the multiplier 87 provides the drooping characteristic illustrated in FIG. 5 by switching the damping coefficient between a value when ΔF is zero or more and a value when ΔF is less than zero, based on control from the drooping characteristic control circuit 88. The drooping characteristic control circuit 88 outputs the damping coefficient to the multiplier 87 to switch between the damping coefficient when ΔF is zero or more and the damping coefficient when ΔF is less than zero, based on the characteristic specification information that the drooping characteristic control circuit 88 is notified of by the control circuit 75 and based on the ΔF information output from the integrator 86. Needless to say, even when the switching of the damping coefficient is controlled using a difference value between the actual measured value of the frequency of the AC system voltage output from the AC frequency detection circuit 71 and the AC system voltage frequency reference value (Fref), the same effects are obtained.

The adder 90 adds the AC system voltage frequency reference value (Fref) to ΔF indicated by the ΔF information output from the arithmetic unit 89. The multiplier 91 multiplies the AC system frequency output from the adder 90 by 2π. The integrator 92 integrates the angular frequency (ω) output from the multiplier 91 to calculate the phase of the AC system voltage.

Hereinafter, the operation of the distributed power source (power conversion apparatus) 5 of the fifth embodiment will be described with reference to FIGS. 2, 5, and 15 to 17. Upon receiving the characteristic specification information that the communication unit 53 of the distributed power source 5 is notified of by the distributed power source integrated management apparatus 2, the communication unit 53 outputs the characteristic specification information to the control circuit 75 in the inverter control circuit 65. The control circuit 75 outputs the characteristic specification information that the control circuit 75 is notified of by the communication unit 53 to each circuit in the inverter control circuit 65. Note that the control circuit 75 may output all the characteristic specification information to each circuit, or may extract only information necessary for each circuit and output the necessary information to each circuit. The DC-DC conversion circuit 61 illustrated in FIG. 15 controls the charge and discharge power of the storage battery 52 on the basis of a command value output from the DC-DC control circuit 64. In the present embodiment, since the inverter circuit 63 is controlled (voltage controlled) as a voltage source, the DC-DC control circuit 64 controls the charge and discharge power of the storage battery 52 such that the second DC voltage measured by the voltmeter 62 becomes a predetermined voltage.

Next, the operation of the inverter circuit 63 will be described. As described above, the inverter circuit 63 is controlled as a voltage source. Therefore, the inverter control circuit 65 controls the inverter circuit 63 on the basis of the measurement information (the results of measurement of the AC system voltage and the AC system current) output from the current and voltage meter 56 and the characteristic specification information that the inverter control circuit 65 is notified of via the communication unit 53. The results of measurement of the AC system voltage output from the current and voltage meter 56 are input to the AC frequency detection circuit 71. The AC frequency detection circuit 71 detects the frequency (AC system frequency Fout) and the phase of the AC system voltage from the measurement results. For example, the AC frequency detection circuit 71 detects the AC system frequency Fout and the phase (zero crossing point phase), based on detection times of zero crossing points of the AC system voltage (the frequency is calculated using a difference (time interval) between a zero crossing point time previously detected and a zero crossing point time currently detected). The output of the AC frequency detection circuit 71 is input to the frequency generation circuit 72.

In the frequency generation circuit 72, the governor circuit 81 calculates the offset value to be added to the target power value Pref output from the control circuit 75, from the AC system frequency reference value Fref (e.g. 60 Hz) output from the control circuit 75 and the AC system frequency Fout detected by the AC frequency detection circuit 71. The fifth embodiment describes a case where the governor circuit 81 is modeled as a first-order lag system represented by −1/Kgd×(1/(1+S×Tg)), using a governor gain (the reciprocal of speed regulation Kgd) and a governor time constant Tg. Note that the configuration (model) of the governor circuit 81 is not limited to the first-order lag system model, and may, of course, use a model simply multiplied by the governor gain or a complex model such as a second-order lag system.

The output of the governor circuit 81 is added to the target power value (Pref) output from the control circuit 75 by the adder 82, from which the output from the power calculation circuit 84 is subtracted by the subtractor 83. The power calculation circuit 84 calculates AC effective power, based on the measurement information output from the current and voltage meter 56, that is, the results of measurement of the AC system current and the AC system voltage. In the present embodiment, the power calculation circuit 84 calculates the AC effective power, but the present invention is not limited thereto. It goes without saying that an instantaneous power value may be calculated on the basis of the measurement information output from the current and voltage meter 56, and the power value may be calculated on the basis of the calculation result.

The output of the subtractor 83 is input to the arithmetic unit 89. Specifically, the output of the subtractor 83 from which the output of the multiplier 87 has been subtracted by the subtractor 85 is input to the integrator 86. The integrator 86 divides the output of the subtractor 85 by M and integrates the division result to calculate the difference frequency (ΔF) from the AC system frequency reference value Fref. The output of the integrator 86 is input to the multiplier 87, the drooping characteristic control circuit 88, and the adder 90. The adder 90 adds the AC system frequency reference value Fref output from the control circuit 75 to the output of the integrator 86, to calculate the frequency of the AC system voltage to be output from the inverter circuit 63. On the other hand, the multiplier 87 multiplies the output of the integrator 86 by the damping coefficient D, and inputs the result of the multiplication to the subtractor 85.

As described above, the distributed power source 5 according to the present embodiment has, for example, the drooping characteristic illustrated in FIG. 5. For the drooping characteristic illustrated in FIG. 5, the drooping characteristic has different slopes with ΔF=0 as the boundary. In the fifth embodiment, the drooping characteristic illustrated in FIG. 5 is achieved by the drooping characteristic control circuit 88 switching the damping coefficient based on the ΔF information output from the integrator 86. Thus, the drooping characteristic control circuit 88 is configured to switch two types of damping coefficient output from the control circuit 75 (two types of the damping coefficient used when ΔF≥0 and the damping coefficient used when ΔF<0) according to the sign of ΔF output from the integrator 86. Here, an example of using the output of the integrator 86 for switching the damping coefficient has been described, but the present invention is not limited thereto. For example, using the result of subtraction of the AC system frequency reference value Fref output from the control circuit 75 from the frequency of the AC system voltage detected by the AC frequency detection circuit 71, of course, achieves the same effects. Furthermore, for the drooping characteristic illustrated in FIG. 9, it goes without saying that a notification of the difference frequency at the point 313 or the point 316 serving as a break point may be provided, and the damping coefficient may be switched according to the magnitude relationship with the difference frequency to control the AC system voltage to be output from the inverter circuit 63.

The output of the adder 90 is input as the frequency of a target AC voltage to the AC voltage target value generation circuit 73, and is input to the multiplier 91 and multiplied by 2π to be converted into the angular velocity ω. The angular velocity ω output from the multiplier 91 is integrated by the integrator 92, converted into phase information θ, and input to the AC voltage target value generation circuit 73. The AC voltage target value generation circuit 73 generates an AC target voltage value to be used in the voltage control circuit 74 on the basis of AC system voltage information output from the control circuit 75, and AC system voltage frequency information and phase information output from the frequency generation circuit 72. The voltage control circuit 74 generates a control command to control the inverter circuit 63 on the basis of the AC voltage target value output from the AC voltage target value generation circuit 73 and the measurement information (the result of measurement of the AC system voltage and the result of measurement of the AC system current) output from the current and voltage meter 56, and outputs the control command to the inverter circuit 63. Although detailed description is omitted, the result of measurement of the AC system current output from the current and voltage meter 56 is used to limit the output current when the inverter circuit 63 attempts to output a current more than or equal to the rated capacity.

The distributed power source 5 (power conversion apparatus) of the present embodiment is configured as described above, and thus can provide the drooping characteristic illustrated in FIG. 5 by the frequency generation circuit 72 on the basis of the information (Pref, Fref, the speed regulation Kgd, the governor time constant Tg, the inertia constant M, the damping coefficient D (two types), and the damping coefficient switching frequency information) used to generate the drooping characteristic output from the distributed power source integrated management apparatus 2. This provides the effects that even when the AC current output from the inverter circuit 63 abruptly increases due to a sudden change in the load, for example, an imbalance in the output power sharing ratio between the distributed power sources can be prevented, and further, the frequency of the AC system voltage output from the inverter circuit 63 can be kept within a range that can be controlled by the distributed power source 5. In the fifth embodiment, the drooping characteristic is achieved by the virtual synchronous generator control as illustrated in FIG. 17, but the present invention is not limited thereto. A drooping characteristic table may be generated based on the information used to generate the drooping characteristic output from the distributed power source integrated management apparatus 2, and the frequency of the AC system voltage when controlled by the voltage control circuit 74 may be controlled using the generated drooping characteristic table, to provide the same effects. The drooping characteristic is not limited to that illustrated in FIG. 5. It goes without saying that if the drooping characteristic is determined such that the voltage frequency monotonically decreases with respect to the output power as illustrated in FIGS. 6, 9, 10, and 13, the same effects are achieved.

The configurations described in the above embodiments illustrate an example and can be combined with another known art. The embodiments can be combined with each other. The configurations can be partly omitted or changed without departing from the gist.

### REFERENCE SIGNS LIST

1 energy management apparatus; 2, 2a, 2b distributed power source integrated management apparatus; 3 distribution transformer; 4 distribution line; 5 distributed power source; 6 load; 7 photovoltaic equipment; 8 communication network; 9 synchronous generator; 11 power demand prediction unit; 12 supply and demand plan creation unit; 13 command value determination unit; 14, 23, 53 communication unit; 15, 24 storage unit; 21, 21a drooping characteristic determination unit; 22 characteristic specification information generation unit; 51 PCS; 52 storage battery; 54 control arithmetic unit; 55 power conversion circuit; 56 current and voltage meter; 60, 63 inverter circuit; 61 DC/DC conversion circuit; 62 voltmeter; 64 DC/DC control circuit; 65 inverter control circuit; 71 AC frequency detection circuit; 72 frequency generation circuit; 73 AC voltage target value generation circuit; 74 voltage control circuit; 75 control circuit; 81 governor circuit; 82, 90 adder; 83, 85 subtractor; 84 power calculation circuit; 86, 92 integrator; 87, 91 multiplier; 88 drooping characteristic control circuit; 89 arithmetic unit; 100, 100a power system management system.

1.-22. (canceled)

23. A distributed power source integrated management apparatus to manage a plurality of distributed power sources connected to an independent power system to operate as voltage sources and to operate such that voltage frequencies vary according to output power and the voltage frequencies become the same, the apparatus comprising:
drooping characteristic determination circuitry to determine a drooping characteristic that determines a relationship between the output power and an output voltage frequency of each of a controlled distributed power source that is at least some of the plurality of distributed power sources, using output power command values that are command values for the output power of the plurality of distributed power sources; and
communication circuitry to notify the controlled distributed power source of characteristic specification information that is information indicating the drooping characteristic, wherein
when determining the drooping characteristic of each of the controlled distributed power source, the drooping characteristic determination circuitry determines the drooping characteristic such that the voltage frequency matches a frequency lower limit when the output power of each distributed power source matches a rated output value.

24. The distributed power source integrated management apparatus according to claim 23, wherein
the drooping characteristic determination circuitry determines a frequency lower limit that is a lower limit of a possible range of the voltage frequency in advance.

25. The distributed power source integrated management apparatus according to claim 24, wherein when determining the frequency lower limit, the drooping characteristic determination circuitry selects one of uncontrollable distributed power sources that are distributed power sources whose drooping characteristics cannot be controlled from the distributed power source integrated management apparatus, and uses a minimum possible frequency value of a drooping characteristic of the selected uncontrollable distributed power source as the frequency lower limit.

26. The distributed power source integrated management apparatus according to claim 25, wherein the uncontrollable distributed power source is a synchronous generator.

27. The distributed power source integrated management apparatus according to claim 23, wherein
the plurality of distributed power sources including a synchronous generator,
the controlled distributed power source is the distributed power source other than the synchronous generator,
the drooping characteristic determination circuitry sets the voltage frequency when the output power of the synchronous generator becomes a rated output as a frequency lower limit.

28. The distributed power source integrated management apparatus according to claim 23, wherein the drooping characteristic determination circuitry determines the drooping characteristic such that the voltage frequency monotonically decreases as the output power increases.

29. The distributed power source integrated management apparatus according to claim 23, wherein the drooping characteristic determination circuitry determines the drooping characteristic such that the voltage frequency matches a rated frequency when the output power matches corresponding one of the output power command values.

30. The distributed power source integrated management apparatus according to claim 23, wherein the drooping characteristic determination circuitry determines a frequency upper limit that is an upper limit of the voltage frequency, and determines the drooping characteristic of each controlled distributed power source such that the voltage frequency matches the frequency upper limit when a ratio of the output power to a rated output value matches a predetermined value in each of the plurality of distributed power sources.

31. The distributed power source integrated management apparatus according to claim 23, wherein
the drooping characteristic determination circuitry determines a frequency lower limit that is a lower limit of the voltage frequency, and
the drooping characteristic is a characteristic that the voltage frequency monotonically decreases as the output power increases with a discharge direction as positive output power, the voltage frequency matches a rated frequency when the output power matches an output power command value that is a command value for the output power, and the output power matches a rated output value for discharge when the voltage frequency matches the frequency lower limit.

32. The distributed power source integrated management apparatus according to claim 23, wherein
the drooping characteristic determination circuitry determines a frequency upper limit that is an upper limit of the voltage frequency,
the drooping characteristic is a characteristic that the voltage frequency monotonically decreases as the output power increases with a discharge direction as positive output power, the voltage frequency matches a rated frequency when the output power matches an output power command value that is a command value for the output power, and a ratio of the output power to a rated output value when the voltage frequency matches the frequency upper limit matches a predetermined value, and
the predetermined value is between zero and minus one inclusive.

33. The distributed power source integrated management apparatus according to claim 23, wherein the characteristic specification information includes coordinate values through which a line representing the drooping characteristic passes in an output power-voltage frequency plane.

34. The distributed power source integrated management apparatus according to claim 23, wherein the characteristic specification information includes a slope of a line representing the drooping characteristic in an output power-voltage frequency plane and a condition under which the slope changes.

35. The distributed power source integrated management apparatus according to claim 23, wherein the characteristic specification information includes information indicating values of control constants corresponding to the drooping characteristic and a condition under which the values of the control constants change.

36. The distributed power source integrated management apparatus according to claim 35, wherein
the controlled distributed power source is a virtual synchronous generator to perform virtual synchronous generator control in which characteristics corresponding to operating characteristics of synchronous generators are simulatively implemented, and
the control constants are control constants used for the virtual synchronous generator control.

37. The distributed power source integrated management apparatus according to claim 23, wherein
one of the plurality of distributed power sources is a synchronous generator,
the controlled distributed power sources are virtual synchronous generators to perform virtual synchronous generator control in which characteristics corresponding to operating characteristics of synchronous generators are simulatively implemented,
the drooping characteristic determination circuitry determines a frequency lower limit that is a lower limit of the voltage frequency and a frequency upper limit that is an upper limit of the voltage frequency, and
the drooping characteristic determination circuitry determines the drooping characteristic of each controlled distributed power source with the voltage frequency at a point in a straight line representing a drooping characteristic of the synchronous generator at which the output power matches a rated output value for discharge of the controlled distributed power source as the frequency lower limit, and with the voltage frequency at a point in the straight line representing the drooping characteristic of the synchronous generator at which the output power is zero as the frequency upper limit.

38. The distributed power source integrated management apparatus according to claim 23, comprising
command value determination circuitry to determine the output power command values for the plurality of distributed power sources, using demand prediction information indicating a result of prediction of demand in the independent power system and rated output values of the plurality of distributed power sources.

39. A distributed power source management method in a distributed power source integrated management apparatus to manage a plurality of distributed power sources connected to an independent power system to operate as voltage sources and to operate such that voltage frequencies vary according to output power and the voltage frequencies become the same, the method comprising:
determining a drooping characteristic that determines a relationship between the output power and an output voltage frequency of each of a controlled distributed power source that is at least some of the plurality of distributed power sources, using output power command values that are command values for the output power of the plurality of distributed power sources, and determining, when determining the drooping characteristic of each of the controlled distributed power source, the drooping characteristic such that the voltage frequency matches a frequency lower limit when the output power of each distributed power source matches a rated output value; and
notifying the controlled distributed power source of characteristic specification information that is information indicating the drooping characteristic.

40. A non-transitory computer-readable storage medium storing a program causing a distributed power source integrated management apparatus to manage a plurality of distributed power sources connected to an independent power system to operate as voltage sources and to operate such that voltage frequencies vary according to output power and the voltage frequencies become the same, to perform:
determining a drooping characteristic that determines a relationship between the output power and an output voltage frequency of each of a controlled distributed power source that is at least some of the plurality of distributed power sources, using output power command values that are command values for the output power of the plurality of distributed power sources, and determining, when determining the drooping characteristic of each of the controlled distributed power source, the drooping characteristic such that the voltage frequency matches a frequency lower limit when the output power of each distributed power source matches a rated output value; and
notifying the controlled distributed power source of characteristic specification information that is information indicating the drooping characteristic.
